(19) United States
(12) Patent Application Publication
(10) Pub. No.: US 2025/0336556 A1
(43) Pub. Date: Oct. 30, 2025

(54) SHIELDING CHAMBER FOR ACCELERATOR AND CONSTRUCTION METHOD THEREFOR, AND METHOD FOR TESTING ACCELERATOR

(71) Applicant: GE Precision Healthcare LLC, Waukesha, WI (US)

(72) Inventors: Zhefeng Zhang, Chengdu (CN); Guangwei Li, Dalian (CN)

(21) Appl. No.: 19/190,393

(22) Filed: Apr. 25, 2025

(30) Foreign Application Priority Data
Apr. 26, 2024 (CN) 202410511197.9

(51) Int. Cl. G21F 7/00

(52) U.S. Cl. CPC G21F 7/00

(57) ABSTRACT

The present invention relates to a shielding chamber for an accelerator and a construction method therefor, and a method for testing an accelerator. The shielding chamber includes a top wall, a circumferential wall, and a side door. The circumferential wall together with the top wall encloses an inner space, the circumferential wall is configured to have a lateral opening, and the lateral opening communicates with the inner space for the accelerator to enter the inner space through the lateral opening. The side door has a side door body, the side door body is configured to block the lateral opening of the circumferential wall and is movable in a first direction, and the first direction is perpendicular to a plane on which the lateral opening is located.

### CROSS-REFERENCE TO RELATED APPLICATIONS

This application claims priority to Chinese Application No. 202410511197.9, filed on Apr. 26, 2024, the disclosure of which is incorporated herein by reference in its entirety.

### TECHNICAL FIELD

The present invention relates to the technical field of shielding protection, and in particular, to a shielding chamber for performing a shielding performance test on an accelerator.

### BACKGROUND

An accelerator is an important particle acceleration device that is widely applied to fields such as particle physics, medicine, material science, etc. An accelerator can accelerate charged particles to high energy for various experiments, studies, and applications. In the medical field, an accelerator can be used for radiotherapy and radiodiagnosis. For example, in tumor therapies, an accelerator can be used to accelerate charged particles to high energy and direct the high-energy particles to irradiate cancer cells, thereby killing the cancer cells without damaging surrounding normal tissues. However, during both production testing and actual use of an accelerator, the accelerator, in running, produces a large amount of radiation, including radiation of gamma rays, X-rays, and neutrons. Such radiation poses a serious threat to a surrounding environment of the accelerator and to the health of people nearby. Therefore, a radiation test needs to be separately performed on the accelerator before the accelerator is officially installed in an operation scenario, thereby ensuring the safety of the people and environment. After passing the test, a Radiation Safety License (RSL) is acquired. The radiation test needs to be performed in a dedicated shielding chamber to reduce impact of radiation on the surrounding environment and people around. After the RSL is acquired, the accelerator is removed from the shielding chamber and installed in an actual operation scenario.

Existing accelerator shielding measures mainly include: self-shielding of an accelerator as well as construction of a shielding chamber for placing an accelerator. A shielding chamber (sometimes also referred to as a shielding room or an equipment room) generally uses concrete as a shielding material, and is constructed on site. However, an existing shielding chamber and its construction process have the following problems.

First, to achieve a better shielding effect, after an outer wall of an existing shielding chamber is constructed, an accelerator is lifted from above into the shielding chamber by using a large crane, and then a top wall is constructed to ensure that the shielding chamber is sufficiently closed to prevent radiation leakage. However, this construction manner requiring the use of large crane equipment not only increases construction costs and difficulty of the shielding chamber, but also increases a site limitation on shielding chamber construction, requiring at least a space for lifting. In addition, in a process of lifting an accelerator by a crane, it is necessary to use a top portion of the outer wall of the shielding chamber as a support for lifting, and this causes some damage to the outer wall of the shielding chamber and further deteriorates the radiation shielding effect of the shielding chamber.

Second, the on-site construction manner is generally used for existing shielding chamber construction, and requires a large amount of labor to carry out the construction on site. This on-site construction manner not only has a long construction period, but also has high construction costs. In addition, the long construction work period of the existing shielding chamber and the conventional construction manner also result in a greatly extended time to acquire an RSL.

Third, an abandoned existing shielding chamber generally produces a large amount of radioactive waste, including all foundation portions, all outer wall portions, and all top wall portions of the shielding chamber. Such radioactive waste brings considerable challenges with respect to the treatment difficulty and treatment costs of the radioactive waste.

Therefore, it is desirable to improve the existing shielding chamber to overcome at least one of the disadvantages described above.

### SUMMARY

The technical solutions proposed by the present invention are intended to solve one or more of the above-described problems regarding a shielding chamber for shielding protection against an accelerator in the prior art.

According to a first aspect of the present invention, provided is a shielding chamber for an accelerator, and the shielding chamber comprises: a top wall; a circumferential wall, wherein the circumferential wall together with the top wall encloses an inner space, the circumferential wall is configured to have a lateral opening, and the lateral opening communicates with the inner space for the accelerator to enter the inner space through the lateral opening; and a side door, wherein the side door has a side door body, the side door body is configured to block the lateral opening of the circumferential wall and is movable in a first direction, and the first direction is perpendicular to a plane on which the lateral opening is located.

In at least one embodiment of the first aspect of the present invention, the side door further comprises a compressed air driving device, and the compressed air driving device is configured to drive the side door body to move.

In at least one embodiment of the first aspect of the present invention, the compressed air driving device comprises: one or more air cushions located on a bottom surface of the side door body, wherein each of the one or more air cushions is inflatable to jack up the side door body; and a driver, wherein the driver is configured to drive the side door body jacked up by the one or more air cushions to move.

In at least one embodiment of the first aspect of the present invention, the one or more air cushions comprise a plurality of air cushions, and the plurality of air cushions are symmetrically distributed on the bottom surface of the side door body.

In at least one embodiment of the first aspect of the present invention, the side door body comprises an inner portion and an outer portion, and when the side door body blocks the lateral opening of the circumferential wall, the inner portion is located inside the lateral opening, and the outer portion is located outside the lateral opening, wherein the inner portion has an inner height, the outer portion has an outer height, the height of the lateral opening is greater than the inner height and less than the outer height, and wherein a bottom surface of the outer portion is flush with a bottom surface of the inner portion, and a top surface of the outer portion exceeds a top surface of the inner portion.

In at least one embodiment of the first aspect of the present invention, the inner portion of the side door body further comprises a first inner portion and a second inner portion, and when the side door body blocks the lateral opening of the circumferential wall, the first inner portion is closer to the inner space for placing the accelerator than the second inner portion, wherein the first inner portion has a first inner height and the second inner portion has a second inner height, and the first inner height is less than the second inner height, and the lateral opening comprises a first opening portion and a second opening portion, the first opening portion is closer to the inner space for placing the accelerator than the second opening portion, the first opening portion is configured to accommodate the first inner portion of the side door body, and the second opening portion is configured to accommodate the second inner portion of the side door body.

In at least one embodiment of the first aspect of the present invention, the inner portion of the side door body has an inner width, the outer portion thereof has an outer width, and the width of the lateral opening is greater than or equal to the inner width and less than the outer width, wherein each of two opposite side surfaces of the outer portion in the width direction exceeds a respective side surface of the inner portion.

In at least one embodiment of the first aspect of the present invention, the outer portion has a varying outer width, and the varying outer width gradually increases in a direction away from the lateral opening.

In at least one embodiment of the first aspect of the present invention, the inner portion further comprises a reinforced shielding portion, and the reinforced shielding portion is embedded in at least a portion of the inner portion and extends toward the innermost side of the side door body, a bottom surface of the reinforced shielding portion is flush with the bottom surface of the outer portion, and the reinforced shielding portion is made of a material having a stronger radiation blocking capability than another constituent portion of the side door body.

In at least one embodiment of the first aspect of the present invention, a ground of the inner space is formed with a stepped portion for facing the reinforced shielding portion, and the height and position of the stepped portion are such designed that a top surface of the step is higher than the bottom surface of the side door body in a process in which the compressed air driving device is used to drive the side door body to move to the lateral opening.

In at least one embodiment of the first aspect of the present invention, the shielding chamber further comprises a direction guide rail, and the direction guide rail is located near the lateral opening of the circumferential wall and extends in the first direction, to guide movement of the side door body in the first direction.

In at least one embodiment of the first aspect of the present invention, at least one of the top wall, the circumferential wall, and the side door body is formed by assembling a plurality of prefabricated members.

In at least one embodiment of the first aspect of the present invention, each prefabricated member has at least one stepped side edge, and the stepped side edge is configured to match and be assembled with the stepped side edge of another prefabricated member.

In at least one embodiment of the first aspect of the present invention, two adjacent prefabricated members assembled are connected by using a bolt.

In at least one embodiment of the first aspect of the present invention, at least one of the top wall, the circumferential wall, and the side door body comprises a plurality of layers, the plurality of layers comprise an inner layer and an outer layer, the inner layer is close to the inner space for placing the accelerator, and the outer layer is remote from the inner space for placing the accelerator, and the inner layer or the outer layer is separately removable.

In at least one embodiment of the first aspect of the present invention, each layer of the at least one of the top wall, the circumferential wall, and the side door body is formed by assembling one or more prefabricated members, and each prefabricated member has at least one stepped side edge, and the stepped side edge is configured to match and be assembled with the stepped side edge of another prefabricated member.

In at least one embodiment of the first aspect of the present invention, each layer has one or more seams, and the seam is located between two adjacent prefabricated members assembled, wherein the seam on each of the plurality of layers is staggered from the seam on an adjacent layer.

According to a second aspect of the present invention, provided is a method for testing an accelerator, and the method comprises: providing the shielding chamber according to any one of the above-described paragraphs; moving a side door body away from a lateral opening of a circumferential wall; carrying, through the lateral opening, the accelerator in or out of an inner space enclosed by the circumferential wall and a top wall; and moving the side door body to approach and block the lateral opening.

In at least one embodiment of the second aspect of the present invention, the carrying, through the lateral opening, the accelerator in or out of an inner space enclosed by the circumferential wall and a top wall comprises: carrying, by using an automated guided vehicle as a carrier for the accelerator and through the lateral opening, the accelerator in or out of the inner space enclosed by the circumferential wall and the top wall.

According to a third aspect of the present invention, provided is a construction method, and the construction method is used to construct the shielding chamber according to any one of the above-described paragraphs.

### BRIEF DESCRIPTION OF THE DRAWINGS

In order to further describe the previous and other advantages and features in the embodiments of the present invention, more detailed descriptions of the embodiments of the present invention will be presented with reference to the accompanying drawings. It should be understood that these accompanying drawings delineate only typical embodiments of the present invention, and thus will not be considered as a limitation on the scope of protection claimed by the present invention.

FIG. 1 shows a schematic structural diagram of a shielding chamber with a side door not installed in place according to an embodiment of the present invention.

FIG. 2 shows a schematic structural diagram of a side door observed from a first perspective according to an embodiment of the present invention.

FIG. 3 shows a schematic structural diagram of a side door observed from a second perspective according to an embodiment of the present invention.

FIG. 4 shows a schematic structural diagram of a side door observed from a third perspective according to an embodiment of the present invention.

FIG. 5 shows a schematic structural diagram of a shielding chamber with a side door installed in place according to an embodiment of the present invention.

FIG. 6 shows a schematic structural diagram of a prefabricated member according to an embodiment of the present invention.

FIG. 7 shows a flowchart of a method for constructing a shielding chamber according to an embodiment of the present invention.

FIG. 8 shows a schematic diagram of a foundation of a shielding chamber according to an embodiment of the present invention.

FIG. 9 shows a schematic diagram of a circumferential wall of a shielding chamber according to an embodiment of the present invention.

FIG. 10 shows a schematic diagram of a circumferential wall and a top wall of a shielding chamber according to an embodiment of the present invention.

FIG. 11 shows a flowchart of a method for testing an accelerator according to an embodiment of the present invention.

### DETAILED DESCRIPTION

The present invention will be further described below with reference to specific embodiments and the accompanying drawings. More details are set forth in the following description in order to facilitate thorough understanding of the present invention, but it will be clear that the present invention can be implemented in many other forms other than those described herein, and those skilled in the art can, without departing from the essence of the present invention, make similar alterations and modifications according to practical applications. Therefore, the scope of protection of the present invention should not be limited by the content of the specific embodiments.

Specific terms have been used in the present application to describe the embodiments of the present application. For example, “an embodiment”, “another embodiment”, and/or “some embodiments” refer to a certain feature, structure, or characteristic related to at least one embodiment of the present application. Therefore, it should be emphasized and noted that two or more references to “an embodiment”, “another embodiment”, or “some embodiments” in various places in this specification are not necessarily referring to the same embodiment. In addition, certain features, structures, or characteristics of one or more embodiments of the present application may be properly combined.

It should be noted that in the description of the embodiments of the present application, various features are sometimes incorporated into one embodiment, accompanying drawing, or description thereof in the present disclosure for the purpose of streamlining the descriptions disclosed in the present application and aiding in the understanding of one or more embodiments. However, this disclosure method does not mean that the present application object needs more features than the features mentioned in the claims.

In the descriptions of the present disclosure, it should be noted that directions or position relationships indicated by the terms “center”, “upper”, “lower”, “left”, “right”, “vertical”, “horizontal”, and the like described herein are based on the directions or position relationships shown by the accompanying drawings, which are used only for describing the present disclosure and for brevity of description, but do not indicate or imply that an indicated device or component must have a specific direction or must be constructed and operated in a specific direction. Therefore, this cannot be understood as a limitation on the present disclosure. In addition, the terms “first” and “second” are used only for descriptive purposes and cannot be construed as indicating or implying relative importance. In the descriptions of the present disclosure, it should be noted that, unless otherwise expressly specified and defined, the terms “installation”, “connect”, “connection”, and “coupling” should be understood in a broad sense, which, for example, may be a fixed connection or a detachable connection; may be a mechanical connection or an electrical connection; may be a direct connection or an indirect connection by means of an intermediate medium; or may be internal communication between two elements. Those of ordinary skill in the art can understand the specific meanings of the above-described terms in the present disclosure according to the specific situation.

Herein, expressions related to “inner” and “outer” may be used to indicate a degree of proximity to an inner space of a shielding chamber, wherein “inner” is closer to the inner space of the shielding chamber than “outer”.

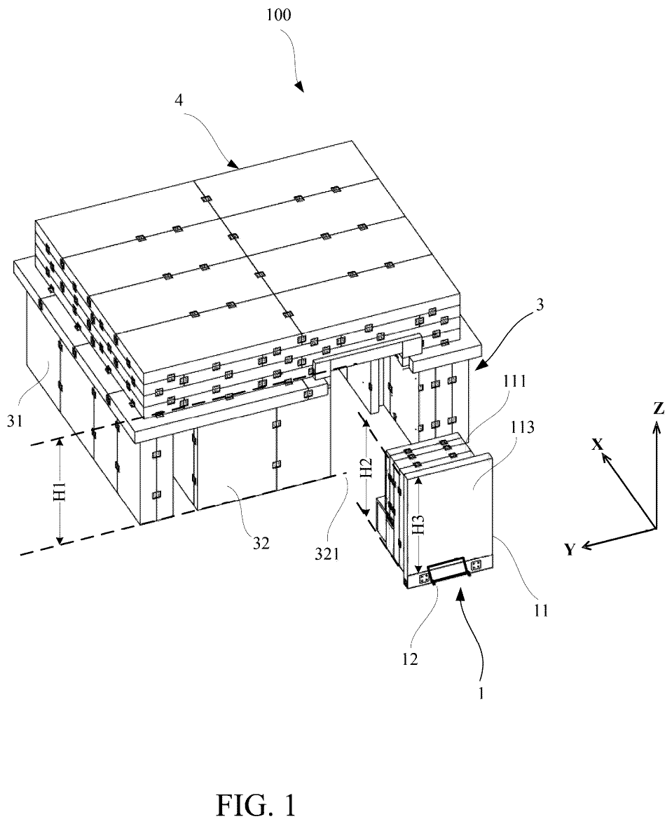

FIG. 1 shows a schematic structural diagram of a shielding chamber 100 with a side door 1 not installed in place according to an embodiment of the present invention. The shielding chamber 100 may be suitable for installing and placing an accelerator (not shown in FIG. 1) therein for performing a radiation test on the accelerator. The shielding chamber 100 can prevent radiation produced by the accelerator from affecting a surrounding environment and people around during the radiation test. As an example, the accelerator may include a cyclotron, a linear accelerator, etc.

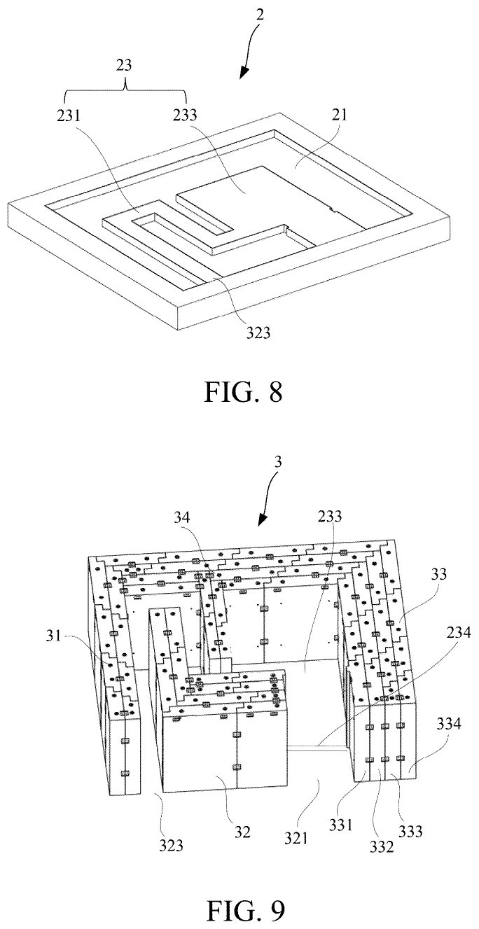

As shown in FIG. 1, the shielding chamber 100 may include a circumferential wall 3 and a top wall 4. In addition, the shielding chamber may further include a foundation 2 (not shown in FIG. 1; see FIG. 8). For clarity, a Cartesian coordinate system is shown in FIG. 1. The circumferential wall 3 may be vertically disposed between the foundation 2 and the top wall 4 substantially along a Z axis, and the foundation 2 and the top wall 4 may be substantially parallel with an X Y plane. The circumferential wall 3 and the top wall 4 may jointly enclose an inner space 233 (not shown in FIG. 1; see FIG. 8 and FIG. 9). The inner space is available for installing and placing an accelerator therein. The circumferential wall 3 may include a wall (e.g., a left wall 31) disposed substantially along an X Z plane and a wall (e.g., a front wall 32) disposed substantially along an Y Z plane. The front wall 32 may have a lateral opening 321, and the lateral opening 321 may extend in the thickness direction of the front wall 32 (e.g., in a X-axis direction) and communicate with the inner space 233 of the shielding chamber 100. The accelerator can enter and exit the inner space 233 of the shielding chamber 100 through the lateral opening 321.

Referring to FIG. 1, the shielding chamber 100 may further include a side door 1, and the side door 1 may include a side door body 11. The side door body 11 may be configured to block the lateral opening 321 of the front wall 32. The side door 1 may further include a compressed air driving device 12, and the compressed air driving device 12 may be configured to drive the side door body 11 to move, e.g., drive the side door body 11 to move in a direction perpendicular to a plane on which the lateral opening 321 is located (i.e., the Y Z plane). In other words, the compressed air driving device 12 may be configured to drive the side door body 11 to move in the X-axis direction.

The shielding chamber 100 may further include a direction guide rail (not shown in the figure). The direction guide rail may be located on a ground near the lateral opening 321 of the front wall 32 and extend in the X-axis direction shown in FIG. 1, to guide movement of the side door body 11 in the X-axis direction. A bottom portion of the side door body 11 may be provided with a mounting portion matching the direction guide rail for mounting. When the side door body 11 is mounted on the direction guide rail through its mounting portion, a moving direction of the side door body 11 may be guided to the X-axis direction shown in FIG. 1 (i.e., the direction perpendicular to the plane on which the lateral opening 321 is located) through the direction guide rail. In some embodiments, the shielding chamber 100 may include two direction guide rails. The two direction guide rails may be symmetrically located on the ground on both sides of the lateral opening 321 and separately extend in the X-axis direction. The bottom portion of the side door body 11 may be provided with two mounting portions for matched mounting on the two direction guide rails, respectively.

By moving the side door body 11 from the lateral opening 321 toward a negative X-axis direction away from the lateral opening 321, the lateral opening 321 of the front wall 32 can be opened to facilitate carry of the accelerator in or out of the shielding chamber 100. This design of the lateral opening 321 of the shielding chamber 100 can avoid a need for the use of large crane equipment, thereby reducing construction costs and difficulty of the shielding chamber 100. In addition, since the accelerator can be conveniently carried in or out of the shielding chamber 100, test operations are allowed to be performed on a plurality of accelerators in the shielding chamber 100. In the present invention, a moving direction (the X-axis direction) of the side door 1 may be perpendicular to the plane on which the lateral opening 321 is located, and the side door body 11 may have a sufficient thickness, e.g., a thickness equivalent to that of the front wall 32. By moving the side door body 11 with the sufficient thickness into the lateral opening 321 toward a positive X-axis direction, the lateral opening 321 of the front wall 32 can be properly closed by the side door body 11 with the sufficient thickness, thereby ensuring a good shielding effect of the shielding chamber 100. The dimensions (e.g., the height, the width, and the thickness) of the side door body 11 may be adaptive to the dimensions of the lateral opening 321, and a surface shape of the side door body 11 may mate with a wall (e.g., formed on the front wall 32 and the top wall 4) of the lateral opening 321, such that the side door body 11 can seal the lateral opening 321 to avoid radiation leakage during testing.

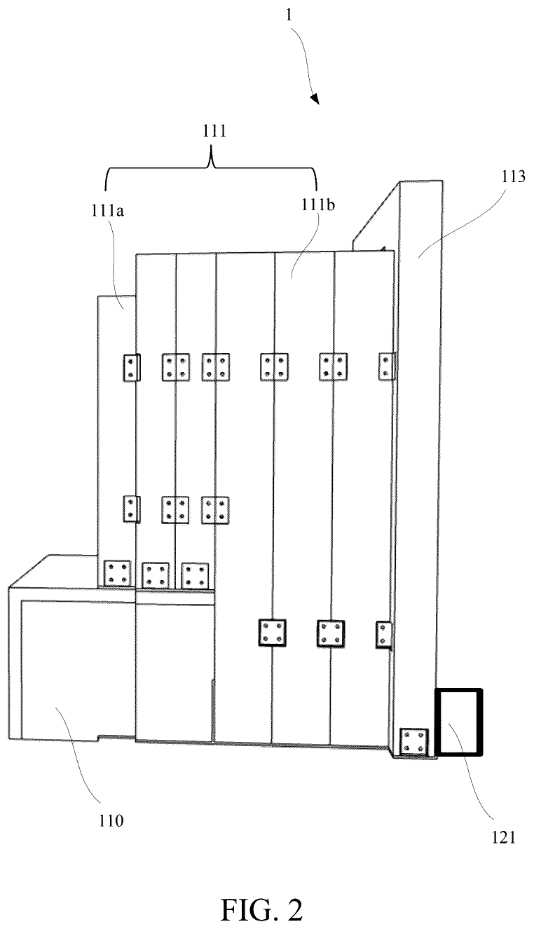

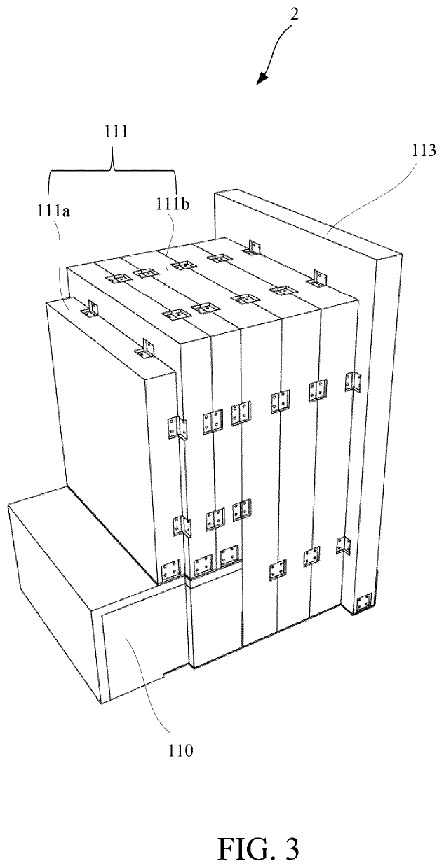

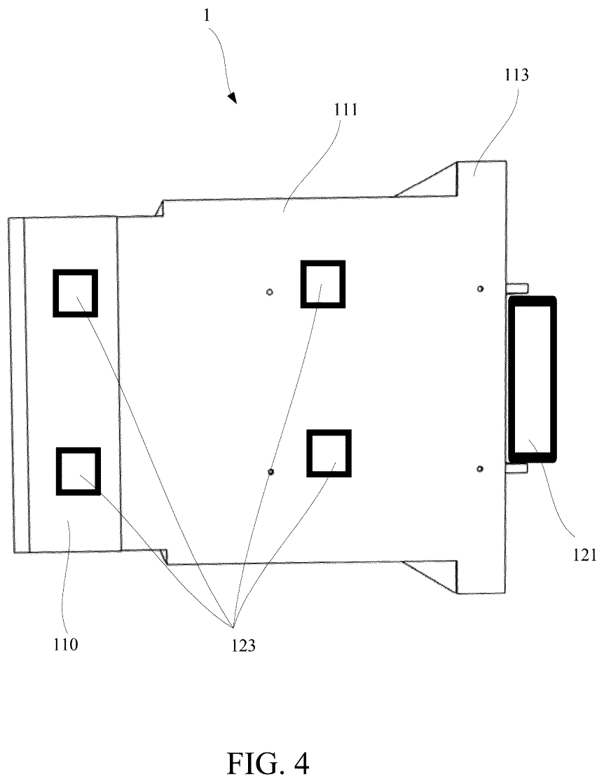

The side door 1 is described below with reference to FIG. 2 to FIG. 4. FIG. 2 shows a schematic structural diagram of a side door 1 observed from a first perspective according to an embodiment of the present invention. FIG. 3 shows a schematic structural diagram of a side door 1 observed from a second perspective according to an embodiment of the present invention. FIG. 4 shows a schematic structural diagram of a side door 1 observed from a third perspective according to an embodiment of the present invention.

As shown in FIG. 2 and FIG. 4, the compressed air driving device 12 may include a driver 121. The driver 121 may be located on an outer side of the side door body 11. As shown in FIG. 4, the compressed air driving device 12 may further include four air cushions 123. These four air cushions 123 may be symmetrically distributed on a bottom surface of the side door body 11. Each of these air cushions 123 may be injected with compressed air via a high-pressure pump (not shown). The high-pressure pump may be located on the outer side of the side door body 11 and may be detachably connected to one end of an air duct (not shown in the figure), and the other end of the air duct may be connected to a compressor. The compressor may be located outside the shielding chamber 100, to provide compressed air. An inflated air cushion 123 can jack up the side door body 11, such that the side door body 11 is off the ground. When the side door body 11 is jacked up by the inflated air cushion 123, the driver 121 may drive the side door body 11 to move. As an example, the driver 121 may be a compressed air driving motor that can convert pressure energy of compressed air into mechanical kinetic energy, thereby driving the side door body 11 to move.

It should be understood that the number (i.e., four) of air cushions 123 shown in FIG. 4 is merely an example rather than a limitation. In another embodiment, the compressed air driving device 12 may include only one air cushion, and the single air cushion may be located on the bottom surface of the side door body 11. In still another embodiment, the compressed air driving device 12 may include another number of air cushions, for example, two, three, five, or more. These air cushions may be symmetrically distributed on the bottom surface of the side door body 11.

In some embodiments, the side door body 11 may be constructed from a concrete material. Due to the need for shielding protection, it is also possible to require the side door body to have a relatively large thickness, which results in a very heavy weight of the side door body 11, e.g., up to 60 tons. To achieve a plurality of repeated and fast movements of the extremely heavy side door body 11, in the present invention, the compressed air driving device 12 including the driver 121 and the air cushions 123 is provided on the side door 1, such that the side door body 11 is jacked up by using inflated air cushions 123 and is off the ground. This greatly reduces a frictional force between the side door body 11 and a contact surface thereof, thereby reducing power needed by the driver 121 to drive the side door body 11 to move, and further promoting fast opening and closing of the lateral opening 321 of the shielding chamber 100 by the side door body 11.

Referring to FIG. 2 to FIG. 4, the side door body 11 may include an inner portion 111 and an outer portion 113. When the side door body 11 blocks the lateral opening 321 of the front wall 32 (i.e. the side door body 11 is installed in place at the lateral opening 321), the inner portion 111 may be located inside the lateral opening 321 while the outer portion 113 may be located outside the lateral opening 321. A bottom surface of the outer portion 113 may be flush with a bottom surface of the inner portion 111, such that when the side door body 11 is installed in place at the lateral opening 321, both the bottom surface of the inner portion 111 and the bottom surface of the outer portion 113 of the side door body 11 may come into contact with the ground or the foundation 2. A top surface of the outer portion 113 of the side door body 11 may exceed a top surface of the inner portion 111, such that when the side door body 11 is installed in place at the lateral opening 321, the outer portion 113 of the side door body 11 may block a gap between the inner portion 111 of the side door body 11 and the lateral opening 321 from above outside the lateral opening 321, so as to prevent radiation produced during running of the accelerator from leakage through the gap.

In some embodiments, as shown in FIG. 2 to FIG. 4, the side door body 11 may further include a reinforced shielding portion 110. The reinforced shielding portion 110 may be embedded into at least a portion of the inner portion 111 and extend toward the innermost side of the side door body 11. As shown in FIG. 2 to FIG. 4, a bottom surface of the reinforced shielding portion 110 may be flush with the bottom surface of the outer portion 113. The reinforced shielding portion 110 may be made of a material having a stronger radiation blocking capability than another constituent portion of the side door body 11. For example, the reinforced shielding portion 110 may include at least one of a boron-containing polyethylene material and a lead material, and the another constituent portion of the side door body 11 may include a concrete material. Compared with the concrete material, the boron-containing polyethylene material or the lead material can more effectively absorb rays and prevent the rays from leakage caused by refraction. In some embodiments, as shown in FIG. 4, a first set of air cushions 123 in the compressed air driving device 12 may be located on the bottom surface of the reinforced shielding portion 110, and a second set of air cushions 123 may be located on a bottom surface of the another constituent portion of the side door body 11 other than the reinforced shielding portion 110.

In some embodiments, the ground in the inner space 233 of the shielding chamber 100 may form a stepped portion 234 (see FIG. 9). The stepped portion 234 may be formed due to the ground height of the inner space 233 being greater than the ground height at the lateral opening 321. The stepped portion 234 may be made opposite to the reinforced shielding portion 110 of the side door body 11 during or after installation of the side door body 11 at the lateral opening 321. The height and position of the stepped portion 234 may be such designed that a top surface of the stepped portion 234 is higher than the bottom surface of the side door body 11 in a process in which the compressed air driving device 12 is used to drive the side door body 11 to move to the lateral opening 321. In the process in which the compressed air driving device 12 is used to drive the side door body 11 to move to the lateral opening 321, the bottom surface of the side door body 11 is jacked up by the air cushions 123 such that the bottom surface of the side door body 11 has a certain height from the ground. At this time, the top surface of the stepped portion 234 may be still higher than the bottom surface of the side door body 11. In this way, radiation can be prevented from leakage through the bottom surface of the side door body 11 that has the certain height from the ground. In addition, when the side door body 11 is installed in place at the lateral opening 321 and the side door body 11 is no longer jacked up by the air cushions 123, the top surface of the stepped portion 234 is still higher than the bottom surface of the side door body 11. At this time, even if there is a gap between the bottom surface of the side door body 11 installed in place and the ground (e.g., a gap caused by unevenness of the bottom surface of the side door body 11 and/or the ground), the higher stepped portion 234 can prevent radiation produced during running of the accelerator from leakage through the gap.

Referring back to FIG. 1, the lateral opening 321 may have a height H1 measured in a Z-axis direction, the inner portion 111 of the side door body 11 may have an inner height H2 measured in the Z-axis direction, and the outer portion 113 of the side door body 11 may have an outer height H3 measured in the Z-axis direction. The height H1 of the lateral opening 321 may be greater than the inner height H2 of the inner portion 111 of the side door body and less than the outer height H3 of the outer portion 113 of the side door body, such that when the side door body 11 blocks the lateral opening 321 of the front wall 32, the inner portion 111 may be located inside the lateral opening 321 and the outer portion 113 may be located outside the lateral opening 321. In some embodiments, the air cushion 123 disposed on the bottom surface of the side door body 11 may have a height difference ΔH before and after inflation, and a height difference acquired by subtracting the inner height H2 of the inner portion 111 of the side door body from the height H1 of the lateral opening 321 may be greater than or equal to the height difference ΔH before and after the air cushion is inflated, so as to allow the inner portion 111 of the side door body 11 jacked up by the inflated air cushion 123 to smoothly enter through the lateral opening 321. The height difference acquired by subtracting the height H1 of the lateral opening 321 from the outer height H3 of the outer portion 113 of the side door body may be greater than or equal to the height difference ΔH before and after the air cushion is inflated, such that after the side door body 11 is installed in place at the lateral opening 321 and the air cushion 123 located on the bottom surface of the side door body 11 is deflated, the outer portion 113 of the side door body 11 may block a gap between the inner portion 111 of the side door body 11 and the lateral opening 321 from above outside the lateral opening 321, so as to prevent radiation produced during running of the accelerator from leakage through the gap.

In a further embodiment, as shown in FIG. 2 and FIG. 3, the inner portion 111 of the side door body 11 may further include a first inner portion 111a and a second inner portion 111b. When the side door body 11 blocks the lateral opening 321 of the front wall 32 (i.e., the side door body 11 is installed in place at the lateral opening 321), both the first inner portion 111a and the second inner portion 111b may be located inside the lateral opening 321, and the first inner portion 111a may be closer to the inner space 233 for placing the accelerator than the second inner portion 111b. A first inner height of the first inner portion 111a of the inner portion 111 of the side door body may be less than a second inner height of the second inner portion 111b. In the embodiment shown in FIG. 2, the inner portion 111 of the side door body may have a stepwise height difference from inside out, that is, the inner portion 111 of the side door body may increase stepwise from the first inner height of the first inner portion 111a to the second inner height of the second inner portion 111b, and a stepwise height difference may occur at a connection between the first inner portion 111a and the second inner portion 111b. In another embodiment, the inner portion 111 of the side door body may have a linearly varying height difference from inside out, that is, the inner portion 111 of the side door body may transition smoothly from the first inner portion to the second inner portion, and may have a varying inner height for both the first inner portion and the second inner portion. The varying inner height gradually increases in a direction away from the lateral opening 321.

Corresponding to the inner portion 111 of the side door body having the first inner portion 111a and the second inner portion 111b of different heights, the lateral opening 321 may also include a first opening portion and a second opening portion of different heights. The first opening portion may be closer to the inner space 233 for placing the accelerator than the second opening portion. The first opening portion may be configured to accommodate the first inner portion 111a of the inner portion 111 of the side door body, and the second opening portion may be configured to accommodate the second inner portion 111b of the inner portion 111 of the side door body. The first opening portion and the second opening portion may be formed by using a separator extending from a top portion of the lateral opening 321 toward the ground. A bottom surface of the second inner portion 111b of the inner portion 111 of the side door body may be flush with a bottom surface of the first inner portion 111a thereof, such that when the side door body 11 is installed in place at the lateral opening 321, both the bottom surface of the second inner portion 111b and the bottom surface of the first inner portion 111a of the inner portion 111 of the side door body may come into contact with the ground or the foundation 2. A top surface of the second inner portion 111b of the inner portion 111 of the side door body may exceed a top surface of the first inner portion 111a thereof, such that when the side door body 11 is installed in place at the lateral opening 321, the second inner portion 111b of the inner portion 111 of the side door body may block, inside the lateral opening 321, a gap between the first inner portion 111a of the inner portion 111 of the side door body and the first opening portion of the lateral opening 321, so as to prevent radiation produced during running of the accelerator from leakage through the gap. With the design of the first inner portion 111a and the second inner portion 111b of the side door body of different heights, in one aspect, the side door body 11 may be enabled to have a sufficient thickness by stacking the first inner portion 111a and the second inner portion 111b in the thickness direction (i.e., the X-axis direction of FIG. 1), thereby ensuring that the shielding chamber 100 has a sufficient shielding effect; in another aspect, the first inner portion 111a with the lower height can reduce the weight of the side door body 11, thereby facilitating fast opening and closing of the lateral opening 321 of the shielding chamber 100 by the side door body 11.

Referring to FIG. 1, the lateral opening 321 may have a width W1 measured in a Y-axis direction, the inner portion 111 of the side door body 11 may have an inner width W2 measured in the Y-axis direction, and the outer portion 113 of the side door body 11 may have an outer width W3 measured in the Y-axis direction. For brevity and clarity of the accompanying drawings, W1 to W3 are not denoted in the drawings. The width W1 of the lateral opening 321 may be greater than or equal to the inner width W2 of the inner portion 111 of the side door body, and the width W1 of the lateral opening 321 may be less than the outer width W3 of the outer portion 113 of the side door body, such that when the side door body 11 blocks the lateral opening 321 of the front wall 32, the inner portion 111 may be located inside the lateral opening 321 and the outer portion 113 may be located outside the lateral opening 321. Each of two opposite side surfaces of the outer portion 113 in the width direction (i.e., the Y-axis direction of FIG. 1) may exceed a respective side surface of the inner portion 111, such that when the side door body 11 is installed in place at the lateral opening 321, the outer portion 113 of the side door body 11 may block a gap between the inner portion 111 of the side door body 11 and the lateral opening 321 from both sides outside the lateral opening 321, so as to prevent radiation produced during running of the accelerator from leakage through the gap.

In a further embodiment, the outer portion 113 of the side door body 11 may have a varying outer width, and the varying outer width gradually increases in the direction away from the lateral opening 321. This gradually increasing outer width can further enhance the sealing performance of the side door body 11 for the lateral opening 321, thereby further improving the radiation shielding effect of the shielding chamber 100.

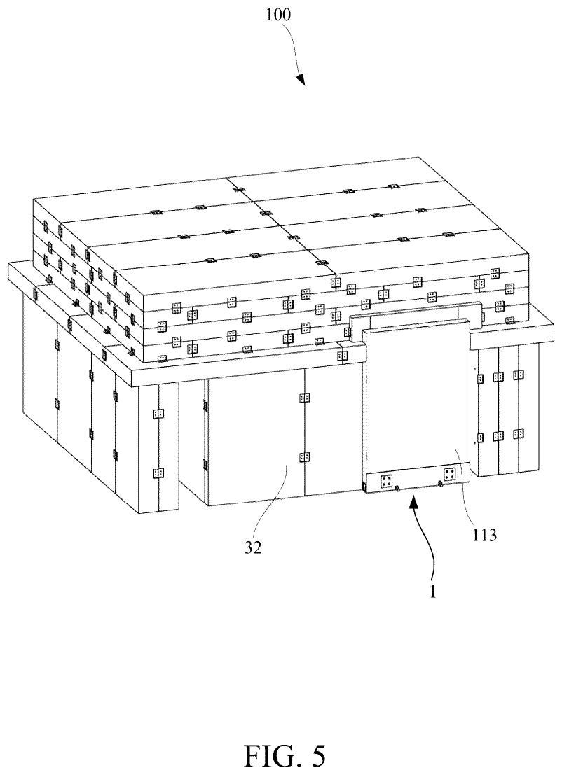

FIG. 5 shows a schematic structural diagram of a shielding chamber 100 with a side door 1 installed in place according to an embodiment of the present invention. As shown in FIG. 5, when the side door 1 is installed in place, the inner portion 111 (not shown in FIG. 5) of the side door body may be located inside the lateral opening 321 (not shown in FIG. 5), and the outer portion 113 thereof may be located outside the lateral opening 321 and an inner side of the outer portion 113 may come into contact with the front wall 32. When observed from the outside of the shielding room 100, the outer portion 113 can fully enclose the lateral opening 321 to prevent radiation produced during running of the accelerator from leakage through the lateral opening 321.

Although the outer contour of the shielding chamber 100 is shown in FIG. 5 as being approximate to the shape of a cube, it should be understood that the outer contour of the shielding chamber 100 may further have another shape, e.g., a hemisphere, a cylinder, or another suitable polyhedral shape.

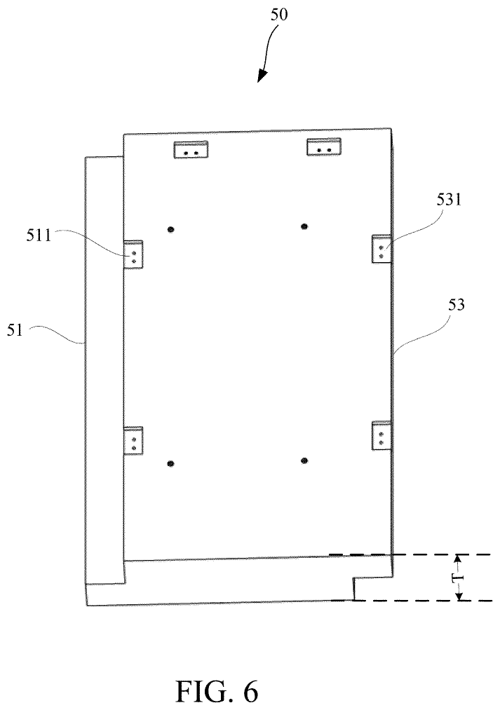

FIG. 6 shows a schematic structural diagram of a prefabricated member 50 according to an embodiment of the present invention. The prefabricated member 50 may be a standardized member mass-produced in advance and may be made of a concrete material or another material suitable for radiation shielding. In some embodiments, the prefabricated member 50 may be configured to form at least one of the side door body 11, the circumferential wall 3, and the top wall 4 of the shielding chamber 100 described above by assembling.

Referring to FIG. 6, the prefabricated member 50 may be an approximately rectangular-shaped member with a certain thickness T. The member has a first stepped side edge 51 and a second stepped side edge 53. However, it should be understood that the shape of the prefabricated member 50 and the number of stepped side edges on the prefabricated member 50 described herein with reference to FIG. 6 are merely exemplary and non-limiting. Those skilled in the art may design a prefabricated member 50 with another shape, or provide another number of stepped side edges on the prefabricated member 50 in accordance with their actual needs.

In some embodiments, as shown in FIG. 6, the first stepped side edge 51 may have a bolt hole 511, and the second stepped side edge 53 may have a bolt hole 531. The bolt holes 511 and 531 may be used for installing bolts. During assembling with another prefabricated member, the stepped side edges of the prefabricated member 50 can match and be assembled with the stepped side edges of the another prefabricated member, respectively, and the adjacent prefabricated members 50 assembled may be connected by bolts installed inside the bolt holes of the stepped side edges.

Since the shielding chamber is required to provide a radiation shielding function, the shielding chamber has higher requirements on the sealing performance of its constituent portions than common buildings. In this case, in the present invention, by disposing the stepped side edge on the prefabricated member 50, a seam between adjacent prefabricated members 50 assembled can be made discontinuous in the thickness direction of the prefabricated members 50. The discontinuous seam can enhance the sealing performance of at least one of the side door body 11, the circumferential wall 3, and the top wall 4 formed by assembling the prefabricated members 50, thereby enhancing the radiation shielding effect of the shielding chamber 100. In addition, in some embodiments of the present invention, at least one of the side door body 11, the circumferential wall 3, and the top wall 4 formed by assembling the prefabricated members 50 is further configured to include a plurality of layers, wherein each layer may be formed by assembling one or more prefabricated members 50 and may have one or more seams (the seam is located between two adjacent prefabricated members assembled), and the seam on each layer is staggered from the seam on an adjacent layer. With the design that at least one constituent portion (e.g., the side door body 11, the circumferential wall 3, or the top wall 4) of the shielding chamber has a plurality of layers and seams on adjacent layers of the plurality of layers are staggered from each other, the present invention can further enhance the sealing performance of at least one of the side door body 11, the circumferential wall 3, and the top wall 4 formed by assembling the prefabricated members 50, thereby further enhancing the radiation shielding effect of the shielding chamber 100.

In addition, in an embodiment in which the shielding chamber 100 is formed by assembling the prefabricated members 50, as the prefabricated members 50 can be produced in advance and assembled on site, there is no need to fabricate a wall and a top wall of the shielding chamber on site as in the past. Therefore, labor construction costs can be reduced, and a construction time of the shielding chamber 100 can be reduced, and the reduction in the construction time of the shielding chamber can in turn reduce a time to acquire an RSL. In addition, the prefabricated member 50 may be produced as a standardized member, and this can allow for standardized construction or mass construction of shielding chambers 100. Shielding chambers constructed in a standardized manner can enable a review and evaluation process of a subsequently constructed shielding chamber during RSL application to be simplified after the first constructed shielding chamber has acquired an RSL, thereby further reduce the time to acquire an RSL.

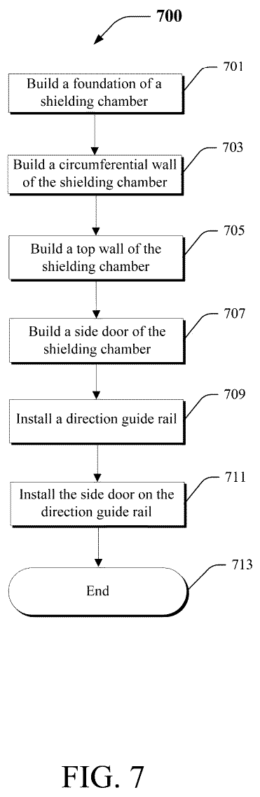

FIG. 7 shows a flowchart of a method 700 for constructing a shielding chamber 100 according to an embodiment of the present invention.

At step 701, a foundation 2 of the shielding chamber 100 is built. In some embodiments, operators (e.g., construction workers) may create the foundation 2 on a ground for constructing the shielding chamber 100, as shown in FIG. 8. FIG. 8 shows a schematic diagram of a foundation 2 of a shielding chamber 100 according to an embodiment of the present invention. As shown in FIG. 8, the foundation 2 may include a wall foundation 21 and an internal passage 23. The wall foundation 21 may be configured to form a circumferential wall 3 thereon. The internal passage 23 may further include a maze passage 231 and an inner space 233 for installing or placing an accelerator. One end of the maze passage 231 may be connected to the inner space 233, the other end thereof may be connected to an entrance 323, and the entrance 323 can allow people to enter the inner space 233 of the shielding chamber 100 therefrom. The maze passage 231 has a bent shape to prevent radiation produced by the accelerator from directly reaching the entrance 323 from the inner space 233. In some embodiments, the maze passage 231 may have a plurality of bending portions, such that radiation from the inner space 233 is blocked by a portion of the maze passage 231 that is closer to the inner space 233, while the remaining passage is exposed to a safe amount of radiation for activities by test personnel.

At step 703, the circumferential wall 3 of the shielding chamber 100 is built. In some embodiments, an operator may assemble a plurality of prefabricated members 50 on the foundation 2 to form the circumferential wall 3 of the shielding chamber 100. In another embodiment, an operator may construct the circumferential wall 3 of the shielding chamber 100 on site on the foundation 2 in a common construction manner. The circumferential wall 3 built at step 703 may be as shown in FIG. 9. FIG. 9 shows a schematic diagram of a circumferential wall 3 of a shielding chamber 100 according to an embodiment of the present invention. As shown in FIG. 9, the circumferential wall 3 may include a left wall 31, a front wall 32, a right wall 33, and a rear wall 34. The front wall 32 may be a discontinuous wall to form a lateral opening 321 for the accelerator to enter and exit the inner space 233 of the shielding chamber 100 and the entrance 323 for people to enter and exit the inner space 233 of the shielding chamber 100. The left wall 31, the right wall 33, and the rear wall 34 may be continuous walls. Referring to FIG. 9, each of the left wall 31, the front wall 32, the right wall 33, and the rear wall 34 of the circumferential wall 3 may have a plurality layers, and the distances of the layers from the inner space 233 may sequentially increase from inside out. In an example of the right wall 33, as shown in FIG. 9, the right wall 33 may have four layers, which are respectively an inner layer 331, a less inner layer 332, a less outer layer 333, and an outer layer 334. The distances of the layers from the inner space 233 sequentially increase from inside out (i.e., from the inner layer 331, to the less inner layer 332, the less outer layer 333, and then the outer layer 334). In some embodiments, each layer of the circumferential wall 3 (e.g., the left wall 31, the front wall 32, the right wall 33, and the rear wall 34) may be sequentially formed by assembling one or more prefabricated members 50. Each layer formed by assembling one or more prefabricated members 50 may have one or more seams, and the seam may be located between two adjacent prefabricated members assembled. The seam on each layer of the circumferential wall 3 may be staggered from the seam on an adjacent layer. The configuration with the seams on adjacent layers of the circumferential wall 3 staggered from each other can enhance the sealing performance of the circumferential wall 3 formed by assembling the prefabricated members 50, thereby enhancing the radiation shielding effect of the shielding chamber 100. In addition, it should be understood that the number of layers of the circumferential wall 3 (including the left wall 31, the front wall 32, the right wall 33, and the rear wall 34) illustrated in FIG. 9 is merely exemplary and non-limiting. Those skilled in the art may adjust the number of layers of the circumferential wall 3 according to their actual needs.

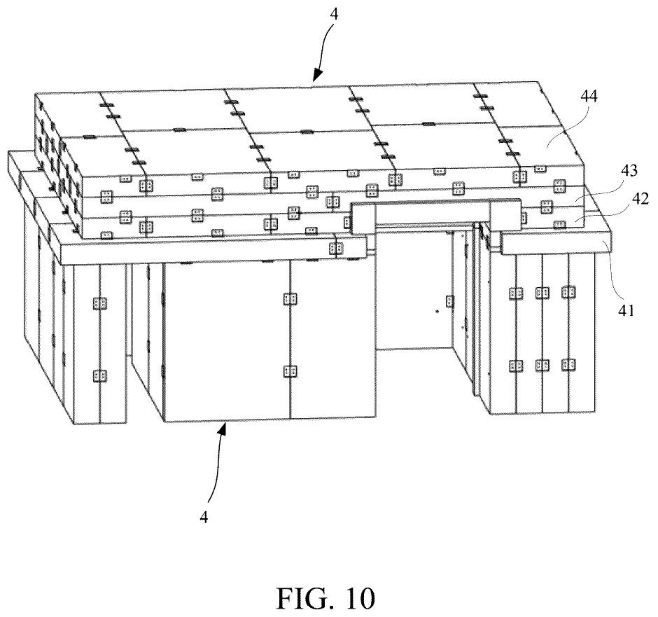

At step 705, a top wall 4 of the shielding chamber 100 is built. In some embodiments, an operator may assemble a plurality of prefabricated members 50 above the circumferential wall 3 to form the top wall 4 of the shielding chamber 100. In another embodiment, an operator may construct the top wall 4 of the shielding chamber 100 on site above the circumferential wall 3 in the common construction manner. The top wall 4 built at step 705 may be as shown in FIG. 10. FIG. 10 shows a schematic diagram of a circumferential wall 3 and a top wall 4 of a shielding chamber 100 according to an embodiment of the present invention. As shown in FIG. 10, the top wall 4 may be located above the circumferential wall 3. The top wall 4 may include four layers, which are respectively an inner layer 41, a less inner layer 42, a less outer layer 43, and an outer layer 44. The distances of the layers from the inner space 233 may sequentially increase from inside out (i.e., from the inner layer 41, to the less inner layer 42, the less outer layer 43, and then the outer layer 44). In some embodiments, each layer of the top wall 4 may be sequentially formed by assembling one or more prefabricated members 50. Each layer formed by assembling one or more prefabricated members 50 may have one or more seams, and the seam may be located between two adjacent prefabricated members assembled. The seam on each layer of the top wall 4 may be staggered from the seam on an adjacent layer. The configuration with the seams on adjacent layers of the top wall 4 staggered from each other can enhance the sealing performance of the top wall 4 formed by assembling the prefabricated members 50, thereby enhancing the radiation shielding effect of the shielding chamber 100. In addition, it should be understood that the number of layers of the top wall 4 illustrated in FIG. 9 is merely exemplary and non-limiting. Those skilled in the art may adjust the number of layers of the top wall 4 according to their actual needs.

At step 707, a side door 1 of the shielding chamber 100 is built. In some embodiments, an operator may assemble a plurality of prefabricated members 50 to form a side door body 11 of the side door 1 of the shielding chamber 100, and then may install one or more air cushions 123 on a bottom surface of the side door body 11 and install a driver 121 on the side door body 11 to form the side door 1 of the shielding chamber. In another embodiment, an operator may construct the side door body 11 of the side door 1 of the shielding chamber 100 on site in the common construction manner, and then may install one or more air cushions 123 on the bottom surface of the side door body 11 and install the driver 121 on the side door body 11 to form the side door 1 of the shielding chamber. The side door 1 built at step 707 may be as shown in FIG. 2 and FIG. 3. As shown in FIG. 2 and FIG. 3, the side door body 11 may have a plurality of layers. When the side door body 11 blocks the lateral opening 321 of the front wall 32 (i.e., the side door body 11 is installed in place at the lateral opening 321), the distances of the layers of the side door body 11 from the inner space 233 may sequentially increase from inside out. As shown in FIG. 2 and FIG. 3, the side door body 11 may have seven layers, the innermost layer may be a first inner portion 111a of the side door body 11, the five intermediate layers may compose a second inner portion 111b of the side door body 11, and the outermost layer may be an outer portion 113 of the side door body. In some embodiments, each layer of the side door body 11 may be sequentially formed by assembling one or more prefabricated members 50. Each layer formed by assembling one or more prefabricated members 50 may have one or more seams, and the seam may be located between two adjacent prefabricated members assembled. The seam on each layer of the side door body 11 may be staggered from the seam on an adjacent layer. The configuration with the seams on adjacent layers of the side door body 11 staggered from each other can enhance the sealing performance of the side door body 11 formed by assembling the prefabricated members 50, thereby enhancing the radiation shielding effect of the shielding chamber 100. In addition, it should be understood that the number of layers of the side door body 11 illustrated in FIG. 9 is merely exemplary and non-limiting. Those skilled in the art may adjust the number of layers of the side door body 11 according to their actual needs. It should be further understood that the step 707 is not limited to being performed after step 705, but may be performed after or before any of steps 701, 703, and 705 described above.

At step 709, a direction guide rail is installed. In some embodiments, an operator may install the direction guide rail near the lateral opening 321 of the front wall 32, and the installed direction guide rail may extend in the X-axis direction shown in FIG. 1, to guide movement of the side door body 11 in the X-axis direction. It should be understood that the step 709 is not limited to being performed after step 707, but may be performed after or before any of steps 703, 705, and 707 described above.

At step 711, the side door 1 is installed on the direction guide rail. In some embodiments, an operator may install the side door 1 built at the step 707 on the direction guide rail, e.g., install the side door 1 on the direction guide rail by matched mounting between a mounting portion at the bottom portion of the side door body 11 and the direction guide rail. The side door 1 installed on the direction guide rail can move in an extension direction of the direction guide rail.

At step 713, the method 700 for constructing the shielding chamber 100 ends.

In an embodiment in which at least one constituent portion (including the top wall 4, the circumferential wall 3, or the side door 1) of the shielding chamber 100 has a plurality of layers, since each layer of this constituent portion (or these constituent portions) has a different distance from the space for placing an accelerator, it is allowed to perform different waste treatment manners on different layers of the constituent portion of the shielding chamber 100 that is abandoned. For example, a common building waste treatment is performed on the outermost layer or the second outermost layer of constituent portions of the shielding chamber 100, a radioactive waste treatment is performed only on the innermost layer of the constituent portions of the shielding chamber 100, and there is no need to perform the radioactive waste treatment on all the constituent portions of the entire shielding chamber 100, thereby reducing treatment difficulty and treatment costs of shielding chamber waste. Each layer of the shielding chamber 100 with a plurality of layers may be formed by assembling one or more prefabricated members 50, or may be constructed on site in the common construction manner.

In addition, in the present invention, when the radiation content of a certain layer (e.g., an inner layer of a shielding chamber that is not maintained or an outer layer of a shielding chamber that has been maintained a plurality of times) of the shielding chamber 100 having a plurality of layers distributed from inside out does not meet the standard, it is possible to separately remove only the inner layer or the outer layer of the shielding chamber 100 and rebuild a corresponding inner layer or outer layer, thereby maintaining the shielding chamber 100 and putting it into use again. This can avoid dismantling the entire shielding chamber whose portion exceeds a radiation content standard and reconstructing a shielding chamber, thereby greatly reducing dismantling and construction costs of the shielding chamber.

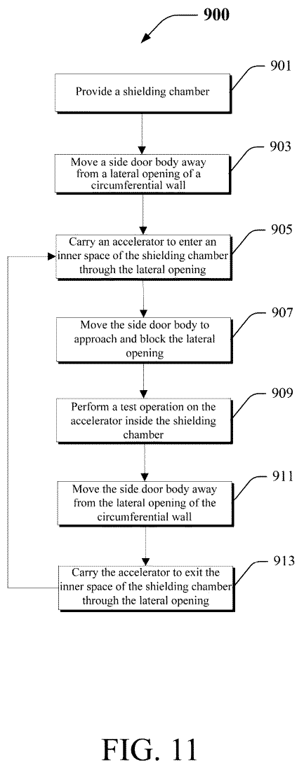

During manufacturing of an accelerator, it is generally necessary to test the accelerator. FIG. 11 shows a flowchart of a method 900 for testing an accelerator according to an embodiment of the present invention. In some embodiments, the method 900 may be performed by using the shielding chamber 100 described above.

At step 901, the shielding chamber 100 is provided. In some embodiments, an operator may construct the shielding chamber 100 with reference to the method 700 described above in conjunction with FIG. 7 to provide the shielding chamber 100 for installing or placing the accelerator.

At step 903, a side door body 11 is moved away from a lateral opening 321 of a circumferential wall 3. In some embodiments, a high-pressure pump may be used to inject compressed air into an air cushion 123 on a bottom surface of the side door body 11, such that the side door body 11 is jacked up, and then a driver 121 on the side door body 11 can drive the side door body 11 jacked up by the inflated air cushion 123 to move toward a direction away from the lateral opening 321 of the circumferential wall 3 (e.g., toward a negative X-axis direction shown in FIG. 1). When the side door body 11 moves to a position sufficiently remote from the lateral opening 321 (this position can allow the accelerator to enter an inner space of the shielding chamber 100 through the lateral opening 321), the driver 131 can stop operating. It should be understood that when an initial position of the side door body 11 is sufficient to allow the accelerator to enter the inner space of the shielding chamber 100 through the lateral opening 321, step 903 may be omitted.

At step 905, the accelerator is carried to enter the inner space of the shielding chamber 100 through the lateral opening 321. In some embodiments, an automated guided vehicle or another tool suitable for carrying the accelerator may be used as a carrier for the accelerator, so as to carry the accelerator into the inner space of the shielding chamber 100 through the lateral opening 321. The accelerator entering into the inner space of the shielding chamber 100 may be installed or placed at a predetermined position in the inner space, so as to perform a test operation on the accelerator. The automated guided vehicle may exit the shielding chamber 100 after completing the carrying work thereof.

At step 907, the side door body 11 is moved to approach and block the lateral opening 321. In some embodiments, the driver 121 on the side door body 11 can drive the side door body 11 jacked up by the inflated air cushion 123 to move toward a direction approaching the lateral opening 321 of the circumferential wall 3 (e.g., toward a positive X-axis direction shown in FIG. 1), until an inner portion 111 of the side door body 11 is located inside the lateral opening 321 and an inner side of an outer portion 113 of the side door body 11 comes into contact with a front wall 32. Next, the air cushion 123 on the bottom surface of the side door body 11 may be deflated, such that the bottom surface of the side door body 11 fits into a foundation 2. At this point, the side door body 11 can successfully block the lateral opening 321.

At step 909, a test operation is performed on the accelerator inside the shielding chamber 100.

At step 911, the side door body 11 is moved away from the lateral opening 321 of the circumferential wall 3. In some embodiments, a high-pressure pump may be used to inject compressed air into the air cushion 123 on the bottom surface of the side door body 11, such that the side door body 11 is jacked up, and then the driver 121 on the side door body 11 can drive the side door body 11 jacked up by the air cushion 123 to move from the lateral opening 321 toward the direction away from the lateral opening 321 of the circumferential wall 3 (e.g., from the lateral opening 321 toward the negative X-axis direction shown in FIG. 1). When the side door body 11 moves to a position sufficiently remote from the lateral opening 321 (this position can allow the accelerator to exit the inner space of the shielding chamber 100 through the lateral opening 321), the driver 131 can stop operating.

At step 913, the accelerator is carried to exit the inner space of the shielding chamber 100 through the lateral opening 321. In some embodiments, an automated guided vehicle or another tool suitable for carrying the accelerator may move into the shielding chamber 100 through the lateral opening 321 that is opened, and may be used as a carrier for the accelerator, so as to carry the accelerator out of the inner space of the shielding chamber 100 through the lateral opening 321.

After one or more accelerators that have been tested are carried out of the shielding chamber, it is possible to return to step 905 to carry another accelerator to be tested into the inner space of the shielding chamber 100 to perform a test operation on the accelerator.

The steps described above with respect to the method 700 and the method 900 are exemplary and not intended to constitute a limitation. Those skilled in the art may add one or more steps, or delete one or more of the above-described steps, or combine or replace one or more of the above-described steps, or adjust an order of one or more of the above-described steps as required.

Although the present invention has been described in accordance with preferred embodiments of the present disclosure, the present invention is not limited thereto but subject only to a limitation of the scope set forth in the appended claims. It should be understood by those skilled in the art that various modifications and changes may be made to the embodiments described herein without departing from the broader spirit and scope of the present invention as set forth in the appended claims.

1. A shielding chamber for an accelerator, comprising:
a top wall;
a circumferential wall, wherein the circumferential wall together with the top wall encloses an inner space, the circumferential wall is configured to have a lateral opening, and the lateral opening communicates with the inner space for the accelerator to enter the inner space through the lateral opening; and
a side door, wherein the side door has a side door body, the side door body is configured to block the lateral opening of the circumferential wall and is movable in a first direction, and the first direction is perpendicular to a plane on which the lateral opening is located.

2. The shielding chamber according to claim 1, wherein the side door further includes a compressed air driving device, and the compressed air driving device is configured to drive the side door body to move.

3. The shielding chamber according to claim 2, wherein the compressed air driving device includes:
one or more air cushions located on a bottom surface of the side door body, wherein each of the one or more air cushions is inflatable to jack up the side door body; and
a driver, wherein the driver is configured to drive the side door body jacked up by the one or more air cushions to move.

4. The shielding chamber according to claim 3, wherein the one or more air cushions include a plurality of air cushions, and the plurality of air cushions are symmetrically distributed on the bottom surface of the side door body.

5. The shielding chamber according to claim 3, wherein the side door body includes an inner portion and an outer portion, and when the side door body blocks the lateral opening of the circumferential wall, the inner portion is located inside the lateral opening, and the outer portion is located outside the lateral opening,
wherein the inner portion has an inner height, the outer portion has an outer height, the height of the lateral opening is greater than the inner height and less than the outer height, and
wherein a bottom surface of the outer portion is flush with a bottom surface of the inner portion, and a top surface of the outer portion exceeds a top surface of the inner portion.

6. The shielding chamber according to claim 5, wherein the inner portion of the side door body further comprises a first inner portion and a second inner portion, and when the side door body blocks the lateral opening of the circumferential wall, the first inner portion is closer to the inner space for placing the accelerator than the second inner portion, wherein the first inner portion has a first inner height and the second inner portion has a second inner height, and the first inner height is less than the second inner height, and
the lateral opening comprises a first opening portion and a second opening portion, the first opening portion is closer to the inner space for placing the accelerator than the second opening portion, the first opening portion is configured to accommodate the first inner portion of the side door body, and the second opening portion is configured to accommodate the second inner portion of the side door body.

7. The shielding chamber according to claim 5, wherein the inner portion of the side door body has an inner width, the outer portion thereof has an outer width, and the width of the lateral opening is greater than or equal to the inner width and less than the outer width,
wherein each of two opposite side surfaces of the outer portion in the width direction exceeds a respective side surface of the inner portion.

8. The shielding chamber according to claim 7, wherein the outer portion has a varying outer width, and the varying outer width gradually increases in a direction away from the lateral opening.

9. The shielding chamber according to claim 5, wherein the inner portion further includes a reinforced shielding portion, and the reinforced shielding portion is embedded in at least a portion of the inner portion and extends toward the innermost side of the side door body,
a bottom surface of the reinforced shielding portion is flush with the bottom surface of the outer portion, and
the reinforced shielding portion is made of a material having a stronger radiation blocking capability than another constituent portion of the side door body.

10. The shielding chamber according to claim 9, wherein a ground of the inner space is formed with a stepped portion for facing the reinforced shielding portion, and
the height and position of the stepped portion are such designed that a top surface of the stepped portion is higher than the bottom surface of the side door body in a process in which the compressed air driving device is used to drive the side door body to move to the lateral opening.

11. The shielding chamber according to claim 1, wherein the shielding chamber further includes a direction guide rail, and the direction guide rail is located near the lateral opening of the circumferential wall and extends in the first direction, to guide movement of the side door body in the first direction.

12. The shielding chamber according to claim 11, wherein at least one of the top wall, the circumferential wall, and the side door body is formed by assembling a plurality of prefabricated members.

13. The shielding chamber according to claim 12, wherein each prefabricated member has at least one stepped side edge, and the stepped side edge is configured to match and be assembled with the stepped side edge of another prefabricated member.

14. The shielding chamber according to claim 13, wherein two adjacent prefabricated members assembled are connected by using a bolt.

15. The shielding chamber according to claim 1, wherein at least one of the top wall, the circumferential wall, and the side door body comprises a plurality of layers, the plurality of layers comprise an inner layer and an outer layer, the inner layer is close to the inner space for placing the accelerator, and the outer layer is remote from the inner space for placing the accelerator, and
the inner layer or the outer layer is separately removable.

16. The shielding chamber according to claim 15, wherein each layer of the at least one of the top wall, the circumferential wall, and the side door body is formed by assembling one or more prefabricated members, and
each prefabricated member has at least one stepped side edge, and the stepped side edge is configured to match and be assembled with the stepped side edge of another prefabricated member.

17. The shielding chamber according to claim 16, wherein each layer has one or more seams, and the seam is located between two adjacent prefabricated members assembled,
wherein the seam on each of the plurality of layers is staggered from the seam on an adjacent layer.

18. A method for testing an accelerator, comprising:
providing the shielding chamber, wherein the shielding chamber includes:
a top wall;
a circumferential wall, wherein the circumferential wall together with the top wall encloses an inner space, the circumferential wall is configured to have a lateral opening, and the lateral opening communicates with the inner space for the accelerator to enter the inner space through the lateral opening; and
a side door, wherein the side door has a side door body, the side door body is configured to block the lateral opening of the circumferential wall and is movable in a first direction, and the first direction is perpendicular to a plane on which the lateral opening is located;
moving a side door body away from a lateral opening of a circumferential wall;
carrying, through the lateral opening, the accelerator in or out of an inner space enclosed by the circumferential wall and a top wall; and
moving the side door body to approach and block the lateral opening.

19. The method according to claim 18, wherein the carrying, through the lateral opening, the accelerator in or out of an inner space enclosed by the circumferential wall and a top wall comprises:
carrying, by using an automated guided vehicle as a carrier for the accelerator and through the lateral opening, the accelerator in or out of the inner space enclosed by the circumferential wall and the top wall.
